(19) United States
(12) Patent Application Publication
(10) Pub. No.: US 2009/0236254 A1
(43) Pub. Date: Sep. 24, 2009

(54) Accessible Hand Hygiene System

(76) Inventors: Shawn E. Jenkins, Duluth, GA (US); Blake A. Hondl, Dunwoody, GA (US); Nancy J. Myers, Dale, WI (US); David J. Tyrrell, Atlanta, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 12/164,255

(22) Filed: Jun. 30, 2008

Related U.S. Application Data
(60) Provisional application No. 61/070,140, filed on Mar. 20, 2008.

(51) Int. Cl. B65D 85/00; B65D 73/00; B67D 5/06; B67D 5/40

(52) U.S. Cl. 206/459.5; 206/484; 222/180; 222/383.1

(57) ABSTRACT

A hand sanitizing kit that includes: at least one single-dose hand sanitizer packet dispensing station component and at least one multiple-dose hand sanitizer dispensing station component. The single-dose hand sanitizer packet dispensing station contains a plurality of single-dose hand sanitizer packets and is adapted to dispense these single-dose hand sanitizer packets. The dispensing station components may include one or more mounts for releasably secure placement or for secure placement of the dispensing station component. The multiple-dose hand sanitizer dispensing station component is a desirably a hand sanitizer pump dispenser. The kit may include instructions or information about positions in a medical setting to locate the single-dose hand sanitizer packet dispensing station component or multiple-dose hand sanitizer dispensing station component to provide accessible hand sanitizing.

This application claims priority from presently copending U.S. Provisional Application No. 61/070,140 entitled “Accessible Hand Hygiene System” and filed on Mar. 20, 2008 in the names of Shawn E. Jenkins and Blake A. Hondl. The entirety of application Ser. No. 61/070,140 is hereby incorporated by reference.

### FIELD OF INVENTION

The present invention relates to hand hygiene. In particular, the invention relates to controlling the spread of pathogens and infectious diseases through hand hygiene.

### BACKGROUND

In recent years, the prevalence of nosocomial infections has had serious implications for both patients and healthcare workers. Nosocomial infections are those that originate or occur in a hospital, long-term care facility, or other health care setting, and are sometimes referred to as “hospital associated infections” or HAI. In general nosocomial infections are more serious and dangerous than external, community-acquired infections because the pathogens in hospitals are more virulent and resistant to typical antibiotics. Nosocomial infections are responsible for about 90,000 deaths in the United States per year. About 5% to 10% of American hospital patients (about 2 million per year) develop a clinically significant nosocomial infection. These HAIs are usually related to a procedure or treatment used to diagnose or treat the patient's illness or injury and may be spread by indirect, inadvertent contact.

Infection control has been a formal discipline in the United States since the 1950s, due to the spread of staphylococcal infections in hospitals. Because there is both the risk of health care providers acquiring infections themselves, and of them passing infections on to patients, the Centers for Disease Control and Prevention have established guidelines for infection control procedures. In addition to hospitals, infection control is important in nursing homes, clinics, physician offices, child care centers, and restaurants, as well as in the home. The purpose of infection control in hospital and clinical environments is to reduce the occurrence of infectious diseases. These diseases are usually caused by bacteria or viruses and can be spread by human to human contact, animal to human contact, human contact with an infected surface, airborne transmission, and, finally, by such common vehicles as food or water. The use of medical devices such as gloves, gowns, and masks as barriers to pathogens is already well appreciated by infection control practitioners. It is apparent by the increase in antibiotic resistance and the persistence of HAIs, however, that these practices alone are not enough.

Hospitals and other healthcare facilities have developed extensive infection control programs to prevent nosocomial infections. Even though hospital infection control programs and a more conscientious effort on the part of healthcare workers to take proper precautions when caring for patients can prevent some of these infections, a significant number of infections still occur. Therefore, the current procedures are not sufficient. Despite enforcement of precautionary measures (e.g. washing hands, wearing gloves, face mask and cover gowns), contact transfer is still a fundamental cause of HAIs. That is, individuals who contact pathogen-contaminated surface such as table tops, bed rails, hands, clothing and/or medical instruments, can still transfer the pathogens from one surface to another immediately or within a short time after initial contact.

Increasing hand hygiene compliance in a hospital setting has proven to be a difficult task in general and particularly for providers of intensive care “ICPs” or other health care workers “HCWs”. While it is well known from the literature that hand hygiene compliance, or lack thereof, is associated with increased risk of patients contracting HAI's, it is often inconvenient for ICPs to wash hands at a traditional hand washing station such as a sink with soap and water. An alternative to washing hands is the use of use hand sanitizers. One of the barriers to improving hand hygiene compliance is lack of hand sanitizer accessibility.

Accordingly, there is an unmet need to improve accessibility of hand sanitizers in a hospital setting or a similar setting where patients are cared for and it is inconvenient wash hands at a traditional hand washing station such as a sink with soap and water. That is, there is an unmet need for a method or system that improves the accessibility of hand sanitizers in a hospital setting where it may be inconvenient to wash hands at a traditional hand washing station such as a sink with soap and water. These settings include, for example, an intensive care unit of a hospital, operating rooms, step-down unit, recovery area, as well as other settings where traditional soap and water might be more available such as, for example, the general hospital floor, hospital hallways, HCW workstations, cafeterias, waiting rooms, and emergency rooms. This unmet need also encompasses a lack of suitable components or articles to provide enhanced accessibility of hand sanitizers in a hospital setting where it may inconvenient to wash hands at a traditional hand washing station such as a sink with soap and water.

### SUMMARY OF THE INVENTION

The present invention is directed to a kit that addresses these unmet needs. In particular, the present invention relates to a hand sanitizing kit that includes: at least one single-dose hand sanitizer packet dispensing station component and at least one multiple-dose hand sanitizer dispensing station component. The single-dose hand sanitizer packet dispensing station contains a plurality of single-dose hand sanitizer packets and is adapted to dispense these single-dose hand sanitizer packets. The single-dose hand sanitizer packets may be dispensed individually (e.g., one-at-a-time) or they may be dispensed in greater quantities such as, for example, two, three or more at-a-time.

In an embodiment of the invention, the single-dose hand sanitizer packets may contain a moisturizing hand sanitizer. Alternatively and/or additionally, some of the single-dose packets may contain a hand moisturizing formulation instead of a hand sanitizer.

According to an aspect of the invention, the single-dose hand sanitizer packet dispensing station component may include one or more mounts for releasably secure placement of the single-dose hand sanitizer packet dispensing station component. That is, the dispensing station may be attached and repositioned without destroying or degrading the dispenser or the mount. Alternatively and/or additionally, the mount or mounts may be for secure placement of the single-dose hand sanitizer packet dispensing station component. The mount may be an adhesive mount or it may be a mechanical (including magnetic) mount or a combination of an adhesive and mechanical mounts.

According to the invention, the multiple-dose hand sanitizer dispensing station component is a desirably a hand sanitizer pump dispenser. It is contemplated that spray dispensers, foam dispensers, pressurized aerosol or pressured foam dispensers, or dip stations may also be used. In an embodiment of the invention, the multiple-dose hand sanitizer dispensing station component may contain a moisturizing hand sanitizer. Alternatively and/or additionally, some of the multiple-dose dispensers may contain a hand moisturizing formulation instead of a hand sanitizer.

The multiple-dose hand sanitizer dispensing station component may include one or more mounts for releasably secure placement of the multiple-dose hand sanitizer dispensing station component. That is, the dispensing station may be attached and repositioned without destroying or degrading the dispenser or the mount. Alternatively and/or additionally, the mount or mounts may be for secure placement of the multiple-dose hand sanitizer dispensing station component. The mount may be an adhesive mount or it may be a mechanical mount or a combination of an adhesive and mechanical mounts.

These mounts may be adapted to secure the multiple-dose hand sanitizer dispensing station component to an IV pole, a bed footboard, bed rail, a wall, wall-mounted rail system, a panel, a shelf, a cart, cart-rails, cart handles, traction pole, computer equipment, a table, a horizontal surface, or a vertical surface.

In an aspect of the present invention, the kit may include instructions or information about positions in a medical setting to locate the single-dose hand sanitizer packet dispensing station component or multiple-dose hand sanitizer dispensing station component to provide accessible hand sanitizing. The instructions or information may also disclose how to locate the components to define a “patient care zone”. The instructions or information may further disclose how to locate or position the components in accordance with fire codes, Americans with Disabilities Act Accessibility Guidelines or other safety, ergonomic or accessibility best practices. Alternatively and/or additionally, the kit may include instructions or information about how to use the single-dose hand sanitizer packets or the single-dose hand sanitizer packet dispensing station component or multiple-dose hand sanitizer dispensing station component, or information providing motivation for or describing benefits of using hand sanitizer. If the single-dose packets include single-dose packets of hand moisturizing formulation or if the multi-dose dispensers contain hand moisturizing formulation, the instructions or information may disclose how to determine or distinguish between packets of hand sanitizer and packets of hand moisturizing formulation and/or how to properly use the hand moisturizing formulation.

In yet another aspect of the invention, the kit may include indicia, markings, coloration, patterns or the like either on the dispensing station components or for application to the dispensing station components or otherwise associated with the dispensing station components (e.g., posters or placards) to enhance visibility or recognition of the dispensing station components, or to provide information or instructions for using the dispensing station components, or to provide motivation, or inspiration to use the dispensing station components, or to create an association between the dispensing station components, or to create an association between the dispensing station components and hand sanitizing.

In an embodiment of the present invention, the single-dose hand sanitizer packet dispensing station component or the multiple-dose hand sanitizer dispensing station component define a planar surface that includes a retaining zone; and the kit may further contain at least one inclusion disposed within the retaining zone, wherein the inclusion is a promotional item, an instruction item or an information item. For example, the inclusion may be removable from the dispensing station component without destroying or degrading the dispensing station component and/or the inclusion. Alternatively and/or additionally, the inclusion may be affixed to or integrated with the retaining in a manner that the inclusion cannot be removed without destroying or degrading the dispensing station component and/or the inclusion.

The inclusion may be an adhesive label such as a sticker, a card that contains indicia, a logo, inspirational or motivational messages, instructions or facts, or coupons or the like.

The present invention also encompasses a system for accessible hand sanitizing in a medical setting. This system includes: (i) at least one single-dose hand sanitizer packet dispensing station components, the single-dose hand sanitizer packet dispensing station containing a plurality of single-dose hand sanitizer packets and being adapted to dispense the single-dose hand sanitizer packets; (ii) a plurality of multiple-dose hand sanitizer dispensing station components; (iii) mounts for at least a portion of the single-dose hand sanitizer packet dispensing station components or multiple-dose hand sanitizer dispensing station components; and (iv) instructions or information about positions in the medical setting to locate the single-dose hand sanitizer packet dispensing station components or multiple-dose hand sanitizer dispensing station components to provide accessible hand sanitizing. The instructions or information may also disclose how to locate the single-dose hand sanitizer packet dispensing station components or multiple-dose hand sanitizer dispensing station components to define a “patient care zone”. The instructions or information may further disclose how to locate or position the components in accordance with fire codes, Americans with Disabilities Act Accessibility Guidelines or other safety, ergonomic or accessibility best practices.

The system may include instructions or information about how to use the single-dose hand sanitizer packets or the single-dose hand sanitizer packet dispensing station component or multiple-dose hand sanitizer dispensing station component, or information providing motivation for or describing benefits of using hand sanitizer. If the single-dose packets include single-dose packets of hand moisturizing formulation or if the multi-dose dispensers contain hand moisturizing formulation, the instructions or information may disclose how to determine or distinguish between packets of hand sanitizer and packets of hand moisturizing formulation and/or how to properly use the hand moisturizing formulation.

The system may also include indicia, markings, coloration, patterns or the like either on the dispensing station components or for application to the dispensing station components or otherwise associated with the dispensing stations components (e.g., posters or placards) to enhance visibility or recognition of the dispensing station components, or to provide information or instructions for using the dispensing station components, or to provide motivation, or inspiration to use the dispensing station components, or to create an association between the dispensing station components, or to create an association between the dispensing station components and hand sanitizing.

In some embodiments, the single-dose hand sanitizer packet dispensing station component or the multiple-dose hand sanitizer dispensing station component may define a planar surface that includes a retaining zone; such that the system of the present invention may further contain at least one inclusion disposed within the retaining zone, wherein the inclusion is a promotional item, an instruction item or an information item. For example, the inclusion may be removable from the dispensing station component without destroying or degrading the dispensing station component and/or the inclusion. Alternatively and/or additionally, the inclusion may be affixed to or integrated with the retaining in a manner that the inclusion cannot be removed without destroying or degrading the dispensing station component and/or the inclusion. The inclusion may be an adhesive label such as a sticker, a card that contains indicia, a logo, inspirational or motivational messages, instructions or facts, or coupons or the like.

The present invention further encompasses a method of enabling hand sanitizing in a medical setting. The method includes: (i) providing at least one single-dose hand sanitizer packet dispensing station components, the single-dose hand sanitizer packet dispensing station containing a plurality of single-dose hand sanitizer packets and being adapted to dispense the single-dose hand sanitizer packets; (ii) providing a plurality of multiple-dose hand sanitizer dispensing station components; (iii) providing mounts for at least a portion of the single-dose hand sanitizer packet dispensing station components or multiple-dose hand sanitizer dispensing station components; and (iv) providing instructions or information about positions in the medical setting to locate the single-dose hand sanitizer packet dispensing station components or multiple-dose hand sanitizer dispensing station components to provide accessible hand sanitizing. The instructions or information may also disclose how to locate the single-dose hand sanitizer packet dispensing station components or multiple-dose hand sanitizer dispensing station components to define a “patient care zone”. The instructions or information may further disclose how to locate or position the components in accordance with fire codes, Americans with Disabilities Act Accessibility Guidelines or other safety, ergonomic or accessibility best practices.

The method may further include providing instructions or information about how to use the single-dose hand sanitizer packets or the single-dose hand sanitizer packet dispensing station component or multiple-dose hand sanitizer dispensing station component, or information providing motivation for or describing benefits of using hand sanitizer. If the single-dose packets include single-dose packets of hand moisturizing formulation or if the multi-dose dispensers contain hand moisturizing formulation, the instructions or information may disclose how to determine or distinguish between packets of hand sanitizer and packets of hand moisturizing formulation and/or how to properly use the hand moisturizing formulation.

The method may also include providing indicia, markings, coloration, patterns or the like either on the dispensing station components or for application to the dispensing station components or otherwise associated with the dispensing station components (e.g., posters or placards) to enhance visibility or recognition of the dispensing station components, or to provide information or instructions for using the dispensing station components, or to provide motivation, or inspiration to use the dispensing station components, or to create an association between the dispensing station components, or to create an association between the dispensing station components and hand sanitizing.

In some embodiments, the single-dose hand sanitizer packet dispensing station component or the multiple-dose hand sanitizer dispensing station component may define a planar surface that includes a retaining zone; such that the method of the present invention may further include providing at least one inclusion disposed within the retaining zone, wherein the inclusion is a promotional item, an instruction item or an information item. For example, the inclusion may be removable from the dispensing station component with out destroying or degrading the dispensing station component and/or the inclusion. Alternatively and/or additionally, the inclusion may be affixed to or integrated with the retaining in a manner that the inclusion cannot be removed without destroying or degrading the dispensing station component and/or the inclusion. The inclusion may be an adhesive label such as a sticker, a card that contains indicia, a logo, inspirational or motivational messages, instructions or facts, or coupons or the like.

Additional features and advantages of the present protective and/or sanitizing articles and associated methods of manufacture will be disclosed in the following detailed description. It is understood that both the foregoing summary and the following detailed description and examples are merely representative of the invention, and are intended to provide an overview for understanding the invention as claimed.

### BRIEF DESCRIPTION OF FIGURES

FIG. 1. is an illustration showing a side view of an exemplary multiple-dose dispensing station component and an exemplary mounting bracket.

FIG. 2. is an illustration showing a front view of an exemplary mounting bracket for use with a multiple-dose dispensing station component.

FIG. 3. is an illustration showing a side view of an exemplary multiple-dose dispensing station component and an exemplary mounting bracket.

FIG. 4. is an illustration showing a front view of an exemplary multiple-dose dispensing station component and an exemplary mounting bracket.

FIG. 5. is an illustration showing a side view of an exemplary mounting bracket for use with a multiple-dose dispensing station component.

FIG. 6. is an illustration showing a perspective view of an exemplary single-dose hand sanitizer packet.

FIG. 7. is an illustration showing a bottom view of an exemplary single-dose hand sanitizer packet.

FIG. 8. is an illustration showing a side view of an exemplary single-dose hand sanitizer packet in use.

FIG. 9. is an illustration showing a side view of an exemplary multiple-dose dispensing station component and an exemplary mounting bracket.

FIG. 10. is an illustration showing a perspective view of an exemplary single-dose hand sanitizer packet dispensing station.

### DETAILED DESCRIPTION OF THE INVENTION

In this specification and the appended claims, the singular forms “a,” “an,” and “the” include plural reference unless the context clearly dictates otherwise. Unless defined otherwise, all technical and scientific terms used herein have the same meaning as commonly understood or generally accepted by one of ordinary skill in the art to which this invention pertains.

As used herein, the term “hand sanitizer” refers to an alcohol-containing gel, foam or liquid solution which may be used as a supplement or alternative to hand washing with soap and water. The active ingredient may be isopropanol, ethanol, or n-propanol. Generally speaking, alcohol concentration should be above 60% to be effective in killing microbes. Hand sanitizers containing two different germ killers (e.g., alcohol and benzalkonium chloride, alcohol and triclosan, etc.) are considered more effective than alcohol alone. Some alcohol-based hand sanitizer formulations include a moisturizer to keep hands from drying out.

As used herein, the term “single-dose packet” refers an article that holds an aliquot of hand sanitizer sufficient for a single hand sanitizing event. The article may be a folded and edged sealed pouch made of a plastic, foil or other material. The pouch is opened by tearing an edge to create access allowing the contents in the interior to be poured or squeezed out. The article may also be a conventional “blister” pack or “bubble” pack that is ruptured or burst. The article may also be a packet or pouch that contains a liquid and is defined by a relative stiff layer that includes a frangible region defining a longitudinal or lateral axis and a relatively flexible film. The frangible region of the relatively stiff layer may be scored or may be composed of an butt weld or seam joining two pieces forming the relatively stiff layer. When the article is folded or bent along the frangible region, the relatively stiff layer splits and separates allowing the contents in the interior to be poured or squeezed out.

As used herein, the term “single-dose packet dispensing station component” refers a article that is adapted to contain a plurality of conventional single-dose packets and provide access to the single-dose packets so they may be retrieved or dispensed individually or in larger quantities. In most cases, the single-dose packets will be single-dose packets of hand sanitizer. It is contemplated that single-dose packets of hand moisturizer may be mixed with the single-dose packets of hand sanitizer or a single-dose packet dispensing station component may contain only single-dose packets of hand moisturizer.

As used herein, the term “multiple-dose hand sanitizer dispensing station component” refers to a device that can dispense hand-sanitizer from a reservoir for multiple hand sanitizing events or multiple users. The multiple-dose hand sanitizer dispensing station may be a hand sanitizer pump dispenser, a pump-spray dispensers, a spray dispenser, a pump-foam dispensers, a foam dispenser, a pressurized aerosol spray dispenser, pressured foam dispensers. The multiple-dose hand sanitizer dispensing station could be a dip station or a saturated towel station (e.g., towel or cloth-like substrate saturated with hand sanitizer).

It is contemplated that spray dispensers or dip stations may also be used. For example, a conventional 540 milliliter pump bottle containing hand sanitizer gel is commercially available under the trade designation Endure 320 from Ecolab. Other desirable pump dispensers include disposable self-contained dispensers having a significantly increased capacity as compared to standard dispensers, which are relatively inexpensive, and which do not depend on the separate storage and delivery of refill cartridges or bulk volumes of liquid ingredients. Examples and descriptions of these dispensers are found at, for example, U.S. Pat. No. 6,729,502 by Lewis, et al., for “Self Contained Viscous Liquid Dispenser”, the contents of which is incorporated herein by reference.

As used herein, the term “patient care zone” refers to an area in an intensive care unit, hospital room, nursing home or other health care setting immediately surrounding a patient's bed side such that a health care worker is located in that area can reach something without moving more than one to two steps from the patient's bed side. Generally speaking, the patient care zone is an area extending less than about 10 feet in at least one horizontal direction from the edge of the patient's bed. Desirably, the patient care zone is an area extending less than about 8 feet in at least one horizontal direction from the edge of a patient's bed. More desirably, the patient care zone is an area extending less than about 6 feet in at least one horizontal direction from the edge of a patient's bed. The patient care zone will desirably extend in several horizontal directions from the edge of a patient's bed. The patient care may include the area immediately adjacent or above a patient's bed. That is, items attached to a patient's bed or suspended or mounted above a patient's bed may be included in the patient care zone.

### Description

The following description is presented to show steps generally thought to be involved in transmission of pathogens and how it can be prevented by using the kit, system and/or method described herein. This description will also demonstrate how multiple types of dispensing stations used together will offer a cumulative or synergistic benefit over a single type of dispensing station alone.

Transmission of pathogens may involve a health care worker (hereinafter referred to as “HCW”) touching a contaminated surface with their hand and then touching and thereby contaminating another person. Alternatively, transmission may involve a first HCW touching a contaminated surface with their hands and then touching an article or garment being worn (e.g., gown, mask or other item) or another surface and thereby contaminating that surface for subsequent contact that may contaminate another HCW's hands or re-contaminate that first HCW's hands after hand sanitizing or washing. The contact transfer from contaminated surfaces to hands to patients or the cycle of contact transfer from contaminated hands to surfaces or articles and then back to hands from is particularly problematic in medical settings where conventional hand washing stations are inconvenient. Examples of these settings include, but are not limited to, an intensive care unit of a hospital, operating rooms, step-down unit, recovery area, as well as other settings where traditional soap and water might be more available such as, for example, the general hospital floor, hospital hallways, HCW workstations, cafeterias, waiting rooms, and emergency rooms.

The invention involves the use of a combination of hand sanitizer dispensers that may be positioned at highly accessible locations to provide more frequent opportunities for hand sanitizing, particularly in these medical settings where conventional hand washing stations are inconvenient. It is believed that more frequent hand sanitizing can help interrupt the cycle of pathogen transmission and that, other factors being equal, improvements in hand hygiene that interrupt the contact transfer of pathogens will also generate a reduction in HAI.

An important feature of the present invention is the combination of single-dose hand sanitizer packet dispensing stations with multiple-dose hand sanitizer (e.g., pump dispenser) dispensing stations. It is thought that enhanced and convenient access to multiple-dose hand sanitizer dispensing stations can enable more frequent hand sanitizing, particularly when such multiple-dose dispensing stations are mounted at highly accessible locations (e.g., an IV pole, a bed footboard, bed rail, a wall, wall-mounted rail system, a panel, a shelf, a cart, cart-rails, cart handles, traction poles, computer equipment, a table, a horizontal surface, or a vertical surface), in combination with readily accessible single-dose hand sanitizer packet dispensing stations that allow HCWs to obtain and carry such single-dose hand sanitizer packets with them for use in situations where hand sanitizing is needed or advisable and even the high-accessible multiple-dose dispensing stations are inconvenient.

The hand sanitizing kit includes: at least one single-dose hand sanitizer packet dispensing station component and at least one multiple-dose hand sanitizer dispensing station component. The single-dose hand sanitizer packet dispensing station contains a plurality of single-dose hand sanitizer packets and is adapted to dispense these single-dose hand sanitizer packets. The single-dose hand sanitizer packets may be dispensed individually (e.g., one-at-a-time) or they may be dispensed in greater quantities such as, for example, two, three or more at-a-time.

The single-dose hand sanitizer packets may be any conventional single-use/single-dose packets containing hand sanitizer. Exemplary packets include the Snap!® brand packages produced by Smyth Companies Inc. of Minneapolis, Minn. Other packets may be Easysnap™ produced by EasyPack Solutions of Bologna, Italy, and SnapPak International of Christchurch, New Zealand.

The multiple-dose hand sanitizer dispensing station component is a desirably a hand sanitizer pump dispenser. It is contemplated that spray dispensers or dip stations may also be used. For example, a conventional 540 milliliter pump bottle containing hand sanitizer gel is commercially available under the trade designation Endure 320 from Ecolab. Other desirable pump dispensers include disposable self-contained dispensers having a significantly increased capacity as compared to standard dispensers, which are relatively inexpensive, and which do not depend on the separate storage and delivery of refill cartridges or bulk volumes of liquid ingredients. Examples and descriptions of these dispensers are found at, for example, U.S. Pat. No. 6,729,502 by Lewis, et al., for “Self Contained Viscous Liquid Dispenser”, the contents of which is incorporated herein by reference.

The single-dose hand sanitizer packet dispensing station component and/or the multiple-dose hand sanitizer dispensing station may include one or more mounts for releasably secure placement of the single-dose hand sanitizer packet dispensing station component. That is, the dispensing station may be attached and repositioned without destroying or degrading the dispenser or the mount. The ability to releasably mount a single-dose hand sanitizer packet dispensing station component and/or the multiple-dose hand sanitizer dispensing station is important to allow HCWs to customize placement of these items so they are more likely to use them. For example, a first HCW may have a first location preference (or series of location preferences) for the single-dose hand sanitizer packet dispensing station component and/or the multiple-dose hand sanitizer dispensing station and a second HCW may have a second location preference (or series of location preferences) for the single-dose hand sanitizer packet dispensing station component and/or the multiple-dose hand sanitizer dispensing station. The ability to easily adjust such items, possibly at the beginning of a shift, either vertically and/or horizontally (or reposition them) to change the location of one or more dispensing stations that is well-suited for a particular health care worker should increase ease of use and the likelihood of use. For example, such a capability to adjust allows the second HCW to relocate the items if that second HCW and the first HCW are providing care during successive shifts in the same area of a hospital or other health care setting.

Alternatively and/or additionally, the mount or mounts may be for secure placement of the single-dose hand sanitizer packet dispensing station component. The mount may be an adhesive mount or it may be a mechanical mount (including magnetic mounts) or a combination of an adhesive and mechanical mounts. Exemplary adhesives include, but are not limited to, conventional pressure sensitive adhesives having levels of tack or adhesion that may be adjusted so they can releasably secure an article or be adjusted such that an article is secured and cannot be removed without destroying or degrading the article. Suitable pressure sensitive adhesive include, but are not limited to, hot-melt “garment” adhesives. Other adhesive materials may include co-adhesive materials that may adhere to itself in a releasable manner. The mount may also be or may include mechanical fasteners such as, for example, Velcro® hook and loop fasteners, other mechanical inter-engaging element type fastening systems, eyes and hooks, snaps, clips, brackets, screws, clamps, strings, magnets, magnetic strips or the like.

In an aspect of the present invention, the kit may include instructions or information about positions in a medical setting to locate the single-dose hand sanitizer packet dispensing station component or multiple-dose hand sanitizer dispensing station component to provide accessible hand sanitizing. For example, the instructions may indicate that the dispensing stations should be located within a minimum distance from one another. Desirably, at least a portion of the dispensing stations are located less than about ten feet (approximately three steps) apart. As an example, the dispensing stations may be located within two to eight feet of one another. As another example, the dispensing stations may be located within five to six feet of one another. As yet another example, the dispensing stations may be located within an arm's reach (about five feet or less) of one another. In some situations, the mix of dispensing station components and density of dispensing station components in an specified area (or in some instances, a specified volume) may influence the relative separation distance. For example, it is contemplated that in certain areas such as, for example, a patient room or multiple patient area may allow for a greater ratio of multiple-dose dispensing station components to single-dose hand sanitizer packet dispensing station components. This ratio may be greater than 4 to 1 or 6 to 1 (or in some instances, even much greater such as, for example, 10 to 1). In such settings, it may be desirable to provide a greater density of such multiple-dose dispensing station components such that the dispensing station components are located within an arm's reach of each other.

In other settings such as HCW computer stations, HCW stations, medical facility hallways or the like, the ratio of multiple-dose dispensing station components to single-dose hand sanitizer packet dispensing station components may be much lower. This ratio may be 2 to 1 or 1 to 1 (or in some instances, even much lower such as, for example, 1 to 2). In such settings, it may be desirable to provide such multiple-dose dispensing station components in very close proximity to the single-dose hand sanitizer packet dispensing station components. Alternatively and/or additionally, it may be desirable to locate individual dispensing station components or clusters of such dispensing station components more than ten feet apart. For example, such dispensing station components or clusters of such components may be located more than fifteen feet apart or more than twenty five feet apart in locations such as in a medical facility corridor or hallway.

In one example, the dispensing station components may be relatively uniformly distributed within a specified area such as, for example, a 15 foot by 15 foot (225 square feet) hospital or medical facility room such that the dispensing station components are present throughout the room. In another example, the dispensing station components may be in a particularly accessible portion of the patient care zone of a specified area such as, for example, a 15 foot by 15 foot (225 square feet) hospital or medical facility room such that the dispensing station components unevenly distributed or concentrated in only portions of the room.

In addition, the instructions or information may also disclose how to locate the components to define a “patient care zone”. That is, the components may be distributed to provide both accessible hand sanitizing and further define an area in an intensive care unit, hospital room, nursing home or other health care setting immediately surrounding a patient's bed side such that a health care worker is located in that area can reach the hand sanitizer components without moving more than one to two steps from the patient's bed side. Although the inventors should not be held to a particular theory of operation, it is thought that a relatively large proportion of HCW events of contamination occur when the HCW has to leave the patient bedside between patient care tasks. Sequential tasks at the patient bedside may require sanitizing between tasks—depending on the task. Critical care tasks require sanitizing if they can endanger the safety of the patient. Defining a “patient care zone” utilizing the dispensing station components, particularly if the components have a distinctive coloration or indicia, will help remind and reinforce the need to sanitize upon return to the patient bedside between patient care tasks.

Generally speaking, the patient care zone is an area extending less than about 10 feet in at least one horizontal direction from the edge of the patient's bed. The patient care zone will desirably extend in several horizontal directions from the edge of a patient's bed and may include the area immediately adjacent or above a patient's bed. Accordingly, the patient care zone can be defined by mounting dispensing station components on locations at the perimeter of the patient care zone and/or within the patient care zone. Exemplary mounting points include, but are not limited to, IV poles (i.e., intravenous therapy pole or intravenous drip pole), bed footboards, bed rails, walls, wall-mounted rail systems, panels, shelves, carts, cart-rails, cart handles, traction poles, computer equipment, tables, horizontal surfaces, and vertical surfaces. One important consideration for locating the dispensing station components is that the dispensing station components must be located outside the reach of the patient. In an embodiment of the invention, the patient care zone can be defined entirely around the bed of a critical care patient by mounting the dispensing station components on bed rails, foot boards, attached IV poles and the like so that the dispensing station components are transported along with the patient allowing HCW to sanitize during transport of the patient.

The instructions or information may further disclose how to locate or position the components in accordance with fire codes, Americans with Disabilities Act Accessibility Guidelines or other safety, ergonomic or accessibility best practices. Alternatively and/or additionally, the kit may include instructions or information about how to use the single-dose hand sanitizer packets or the single-dose hand sanitizer packet dispensing station component or multiple-dose hand sanitizer dispensing station component, or information providing motivation for or describing benefits of using hand sanitizer.

If the single-dose packets include single-dose packets of hand moisturizing formulation or if the multi-dose dispensers contain hand moisturizing formulation, the instructions or information may disclose how to determine or distinguish between packets of hand sanitizer and packets of hand moisturizing formulation and/or how to properly use the hand moisturizing formulation.

The greater access to hand sanitizer, particularly alcohol-based hand sanitizer, may make it desirable to use moisturizing hand sanitizer formulations such as, for example, the formulations described in U.S. Pat. No. 6.228,385 issued May 8, 2001 to Richard L. Shick for “Liquid Antimicrobial Skin Moisturizing Formulation”, the contents of which are incorporated herein by reference. Such formulations may be used in some or all of the single-dose hand sanitizer packets. Alternatively and/or additionally, such formulations may be used in some or all of the multiple-dose hand sanitizer dispensing station components (e.g., the pump dispensers).

It may also be desirable to include conventional hand moisturizer formulations in some of the single-dose packets and distribute or mix some of these single-dose packets with the single-dose hand sanitizer packets. Alternatively and/or additionally, such formulations may be used in some or all of the multiple-dose dispensing station components (e.g., the pump dispensers) in place of hand sanitizer.

In yet another aspect of the invention, the kit may include indicia, markings, coloration, patterns or the like either on the dispensing station components or for application to the dispensing station components to enhance visibility or recognition of the dispensing station components. For example, the dispensing station components may be made of a material having a very bright, highly visible color. Alternatively, the kit may include attachable stickers or panels that are very bright or highly visible. The color may be, for example, any of various bright or highly visible shades of orange or purple or the color may be a primary color. The colors on different components may be different and may be selected to be complementary or provide sufficient contrast to identify different components as being different. It is contemplated that the color may be selected to be associated with hand sanitizing activity and the association may be established and/or reinforced by a variety of techniques including, but not limited to, posters, messages, slogans, computer training, or the like. The kit may include stickers or items that may be affixed to the dispensing stations that include indicia identifying the dispensing station. In an aspect of the invention, the colors and/or indicia may be selected so a patient care zone can be defined by mounting dispensing station components on locations at the perimeter of a patient care zone and/or within a patient care zone. The colors and/or indicia on the dispensing station components may be further supplemented or highlighted by informational or instructional posters. The colors and/or indicia may also be selected to so that an arrangement of the dispensing station components visibly define a hand sanitizing “node” or cluster at, for example, a HCW workstation, a computer station, a hallway location, or other location where such accessible hand sanitizing is desired.

In an embodiment of the present invention, the single-dose hand sanitizer packet dispensing station component or the multiple-dose hand sanitizer dispensing station component define a planar surface that includes a retaining zone; and the kit may further contain at least one inclusion disposed within the retaining zone, wherein the inclusion is a promotional item, an instruction item or an information item. For example, the inclusion may be removable from the dispensing station component without destroying or degrading the dispensing station component and/or the inclusion. Alternatively and/or additionally, the inclusion may be affixed to or integrated within the retaining zone in a manner that the inclusion cannot be removed without destroying or degrading the dispensing station component and/or the inclusion.

The inclusion may be an adhesive label such as a sticker, a card that contains indicia, a logo, inspirational or motivational messages, instructions or facts, or coupons or the like.

The present invention also encompasses a system for accessible hand sanitizing in a medical setting. This system includes: (i) at least one single-dose hand sanitizer packet dispensing station components, the single-dose hand sanitizer packet dispensing station containing a plurality of single-dose hand sanitizer packets and being adapted to dispense the single-dose hand sanitizer packets; (ii) a plurality of multiple-dose hand sanitizer dispensing station components; (iii) mounts for at least a portion of the single-dose hand sanitizer packet dispensing station components or multiple-dose hand sanitizer dispensing station components; and (iv) instructions or information about positions in the medical setting to locate the single-dose hand sanitizer packet dispensing station components or multiple-dose hand sanitizer dispensing station components to provide accessible hand sanitizing.

The system may include instructions or information about how to use the single-dose hand sanitizer packets or the single-dose hand sanitizer packet dispensing station component or multiple-dose hand sanitizer dispensing station component, or information providing motivation for or describing benefits of using hand sanitizer. The instructions or information may also disclose how to locate the components to define a “patient care zone”. The instructions or information may further disclose how to locate or position the components in accordance with fire codes, Americans with Disabilities Act Accessibility Guidelines or other safety, ergonomic or accessibility best practices.

The system may also include indicia, markings, coloration, patterns or the like either on the dispensing station components or for application to the dispensing station components to enhance visibility or recognition of the dispensing station components.

In some embodiments, the single-dose hand sanitizer packet dispensing station component or the multiple-dose hand sanitizer dispensing station component may define a planar surface that includes a retaining zone; such that the system of the present invention may further contain at least one inclusion disposed within the retaining zone, wherein the inclusion is a promotional item, an instruction item or an information item. For example, the inclusion may be removable from the dispensing station component without destroying or degrading the dispensing station component and/or the inclusion. Alternatively and/or additionally, the inclusion may be affixed to or integrated with the retaining in a manner that the inclusion cannot be removed without destroying or degrading the dispensing station component and/or the inclusion. The inclusion may be an adhesive label such as a sticker, a card that contains indicia, a logo, inspirational or motivational messages, instructions or facts, or coupons or the like.

The present invention further encompasses a method of enabling hand sanitizing in a medical setting. The method includes: (i) providing at least one single-dose hand sanitizer packet dispensing station components, the single-dose hand sanitizer packet dispensing station containing a plurality of single-dose hand sanitizer packets and being adapted to dispense the single-dose hand sanitizer packets; (ii) providing a plurality of multiple-dose hand sanitizer dispensing station components; (iii) providing mounts for at least a portion of the single-dose hand sanitizer packet dispensing station components or multiple-dose hand sanitizer dispensing station components; and (iv) providing instructions or information about positions in the medical setting to locate the single-dose hand sanitizer packet dispensing station components or multiple-dose hand sanitizer dispensing station components to provide accessible hand sanitizing.

The method may further include providing instructions or information about how to use the single-dose hand sanitizer packets or the single-dose hand sanitizer packet dispensing station component or multiple-dose hand sanitizer dispensing station component, or information providing motivation for or describing benefits of using hand sanitizer.

The method may also include providing indicia, markings, coloration, patterns or the like either on the dispensing station components or for application to the dispensing station components to enhance visibility or recognition of the dispensing station components.

In some embodiments, the single-dose hand sanitizer packet dispensing station component or the multiple-dose hand sanitizer dispensing station component may define a planar surface that includes a retaining zone; such that the method of the present invention may further include providing at least one inclusion disposed within the retaining zone, wherein the inclusion is a promotional item, an instruction item or an information item. For example, the inclusion may be removable from the dispensing station component without destroying or degrading the dispensing station component and/or the inclusion. Alternatively and/or additionally, the inclusion may be affixed to or integrated within the retaining zone in a manner that the inclusion cannot be removed without destroying or degrading the dispensing station component and/or the inclusion. The inclusion may be an adhesive label such as a sticker, a card that contains indicia, a logo, inspirational or motivational messages, instructions or facts, or coupons or the like.

The various aspects of the present invention may be better understood with reference to the following examples and Figures.

### EXAMPLE 1

This example was provided to illustrate a multi-dose dispensing station component and associated mounting feature in the form of a mounting bracket.

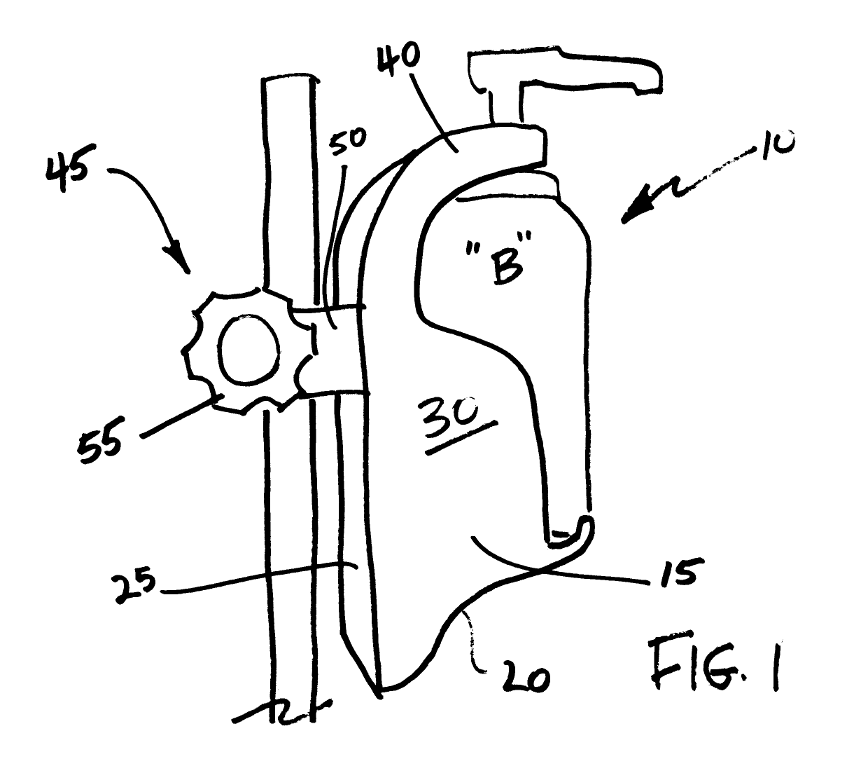

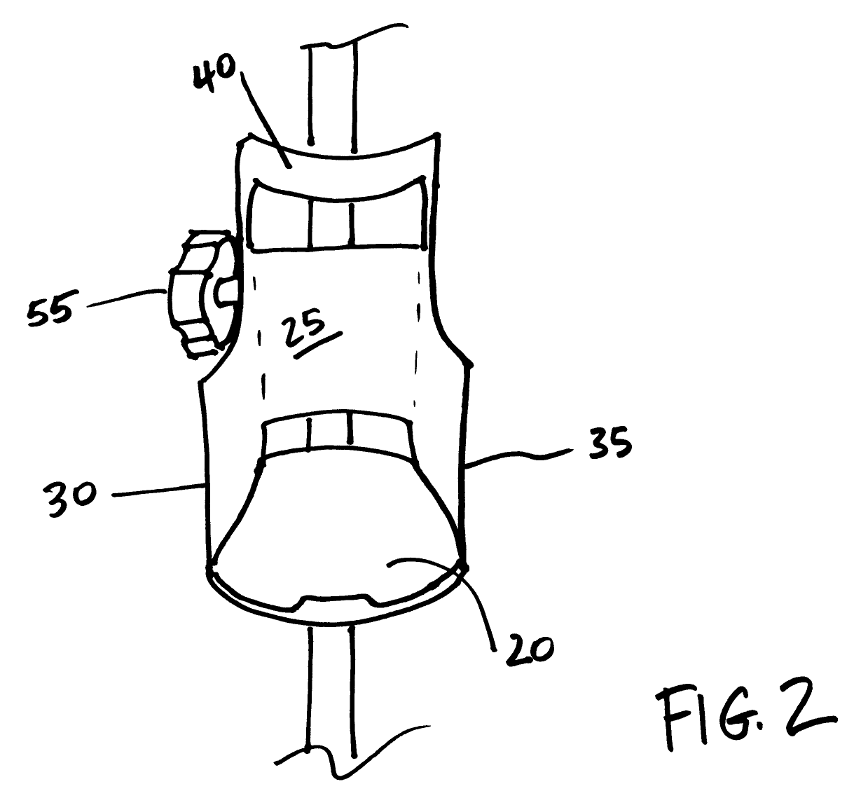

FIG. 1 is an illustration showing a side view of an exemplary multiple-dose dispensing station component 10 and an exemplary mounting bracket 15. As seen in FIG. 1 and also in FIG. 2, which shows a front view of only the mounting bracket, the multiple-dose dispensing station component may be a conventional pump bottle “B” that is held securely within the mounting bracket 15. The mounting bracket has a base 20, a back wall 25, a first side wall 30, a second side wall 35 and a collar 40 that projects from the back wall and side walls to cantilever over the base such that the collar is adapted to secure the neck of a conventional pump bottle. The mounting bracket also includes a clamp 45 attached to the back wall 25 (although it may be attached to other elements). The clamp 45 may be a conventional “U” clamp 50 with a set screw 55 for tightening the clamp to a pole or other article that fits within the “U” slot of the clamp.

### EXAMPLE 2

This example was provided to illustrate a multi-dose dispensing station component and associated mounting feature in the form of a mounting basket.

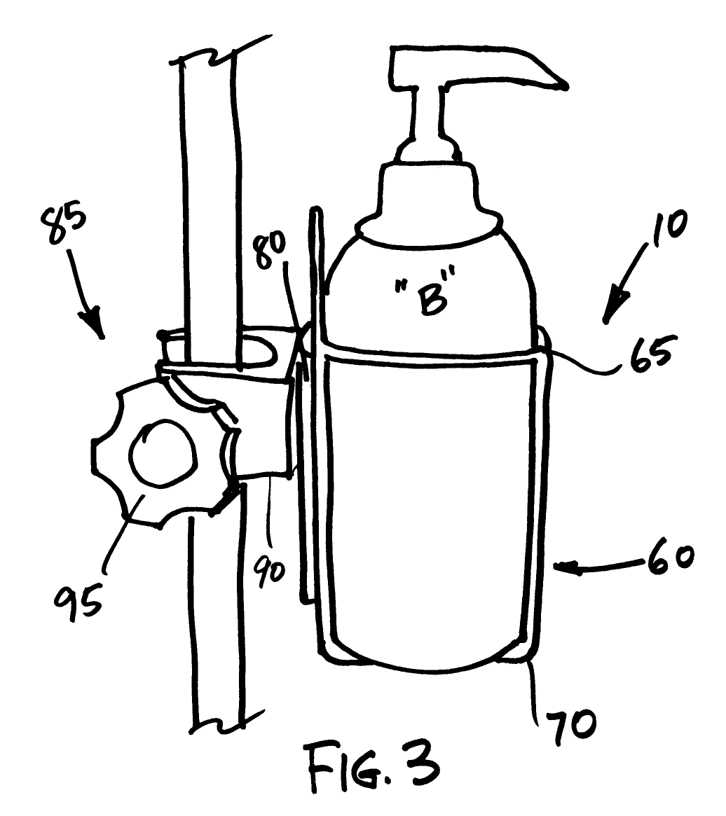

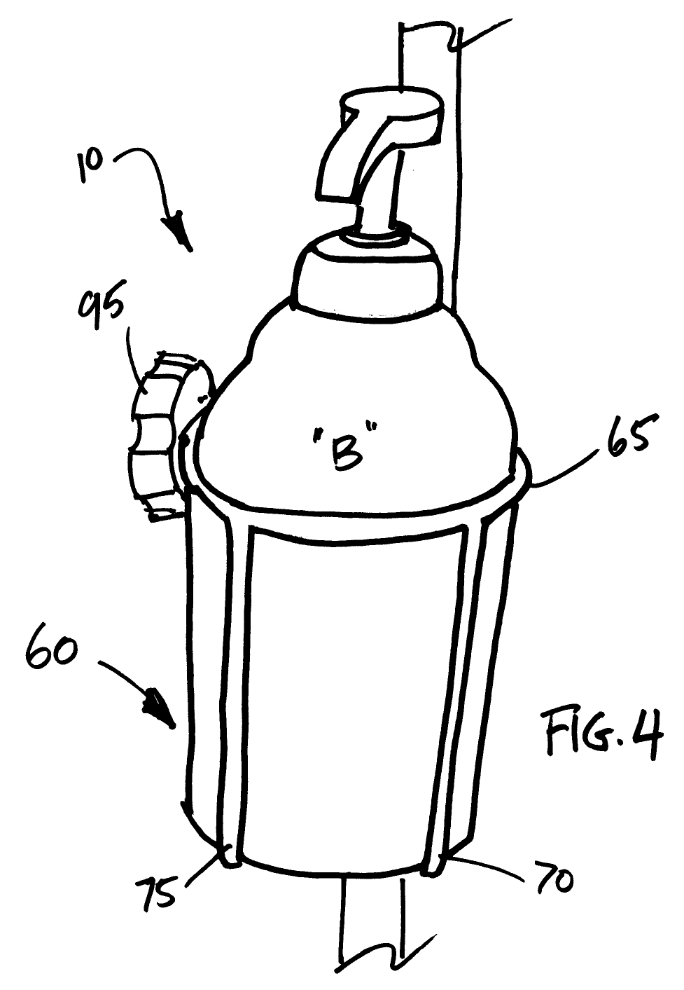

FIG. 3. is an illustration showing a front view of another exemplary multiple-dose dispensing station component 10 and mounting basket 60. As also seen in FIG. 4, which shows a side view, and in FIG. 5 which shows a side view of only the mounting basket 60, the multiple-dose dispensing station component may be a conventional pump bottle “B” that is held securing with the mounting basket 60. The mounting basket 60 has collar 65 and at least two supports 70 and 75 (although one support may be used or more than two supports may be used). A conventional pump bottle fits through the collar and rests on the supports. The mounting basket also includes a plate 80 attached to the supports 70 and 75. A conventional clamp 85 may be engaged with the plate 80 (although it may be attached to other elements). The clamp 85 may be a conventional “U” clamp 90 with a set screw 95 for tightening the clamp to a pole or other article that fits within the “U” slot of the clamp.

### EXAMPLE 3

This example was provided to illustrate a single-dose hand sanitizer dispensing packet.

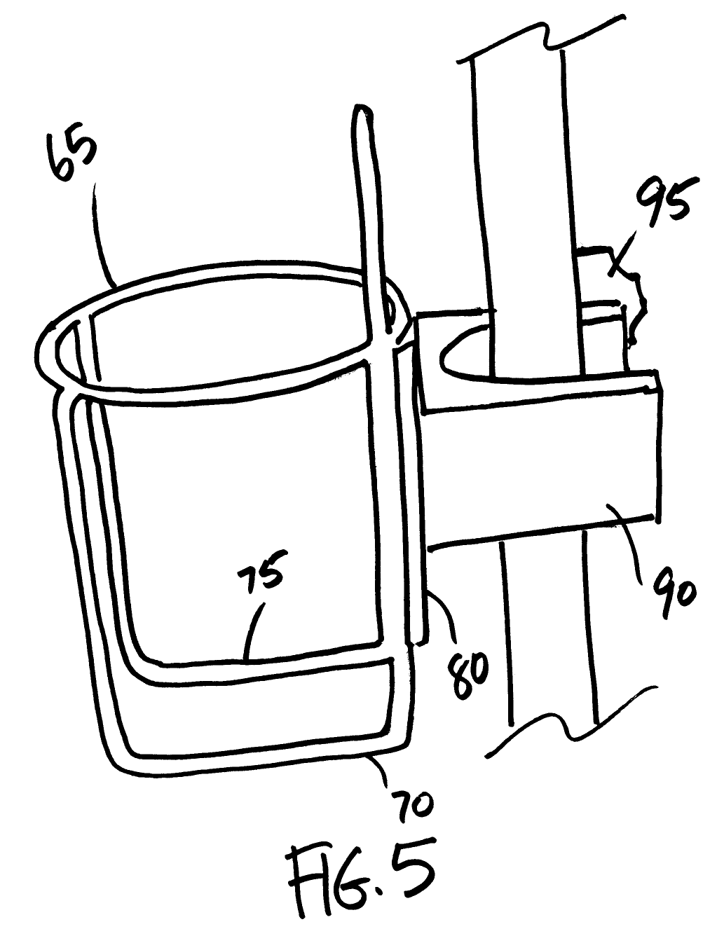

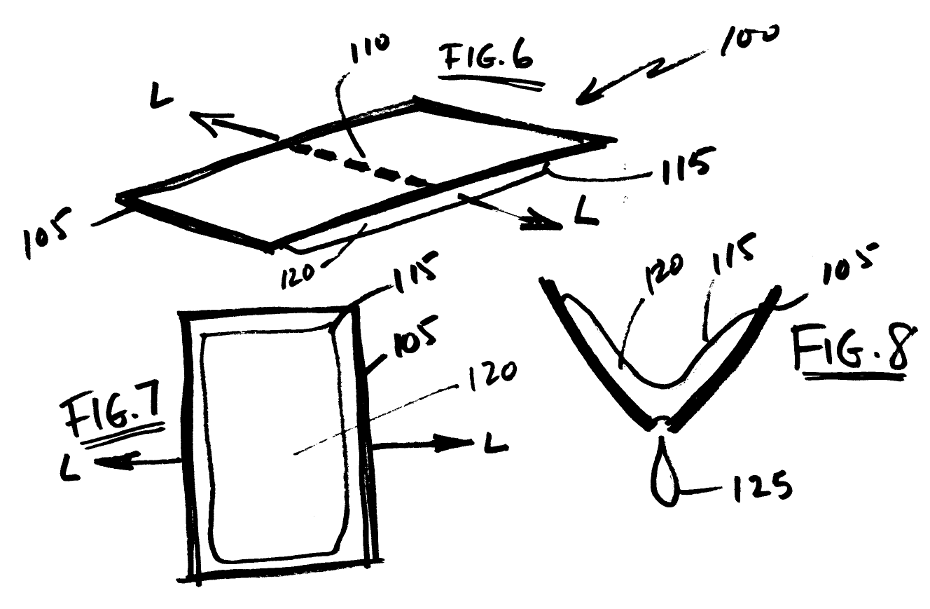

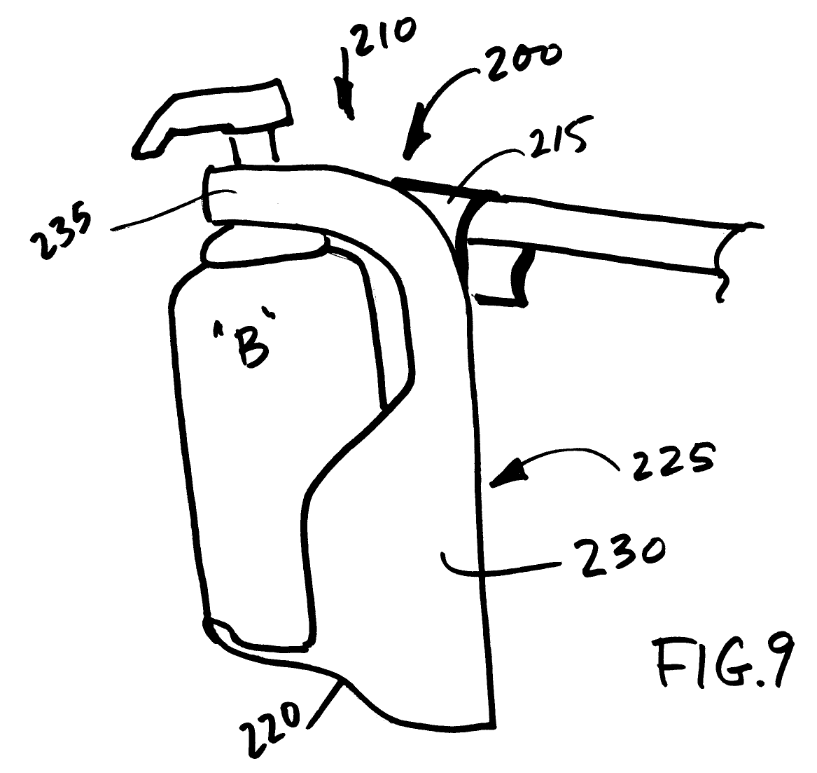

FIG. 6. is an illustration showing a perspective view of an exemplary single-dose hand sanitizer packet 100. As also seen in FIG. 7, which an illustration showing a bottom view of an exemplary single-dose hand sanitizer packet and FIG. 8 which is an illustration showing a side view of an exemplary single-dose hand sanitizer packet in use, the exemplary single-dose hand sanitizer packet 100 includes a relatively stiff layer 105 that has a frangible region 110 defining a longitudinal or lateral axis “L” and a relatively flexible film 115. The relatively stiff layer 105 and the relatively flexible film 115 define a packet or pouch 120 that contains a liquid 125.The frangible region 110 of the relatively stiff layer 105 may be scored or may be composed of an butt weld or seam joining two pieces forming the relatively stiff layer 105. When the article is folded or bent along the frangible region as generally shown in FIG. 8, the relatively stiff layer 105 splits and separates allowing the liquid 125 in the interior to be poured or squeezed out.

### EXAMPLE 4

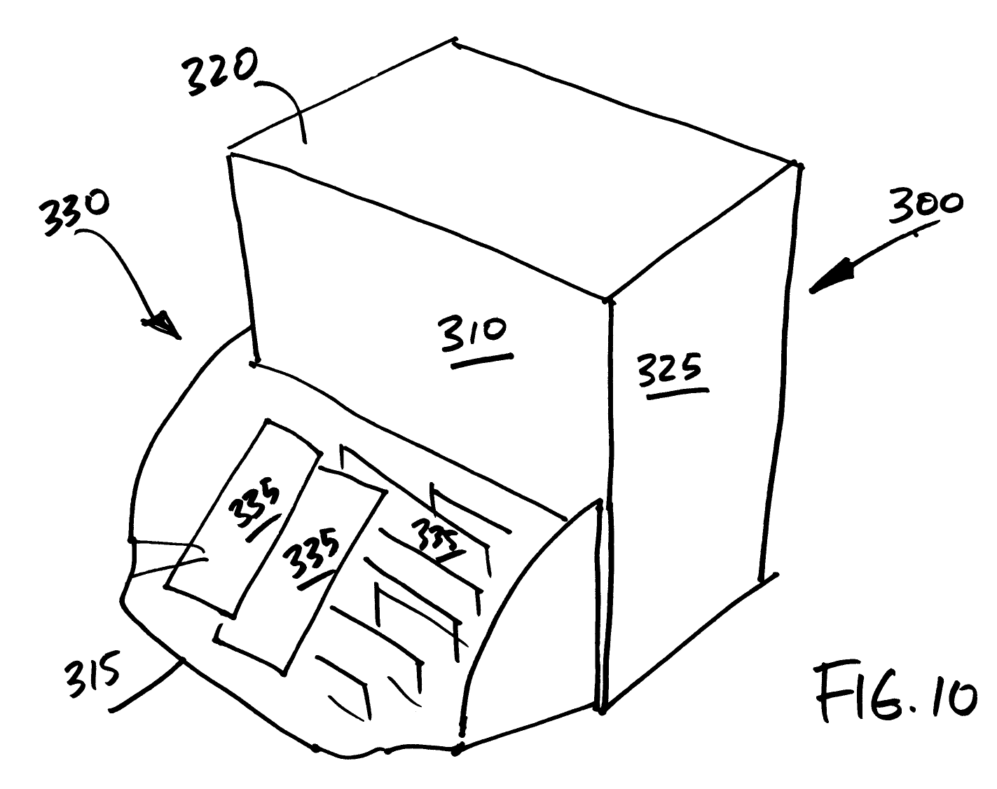

This example was provided to illustrate a multi-dose dispensing station component and associated mounting feature in the form of a mounting clip. FIG. 9 is an illustration showing a side view of an exemplary multiple-dose dispensing station component 200 and an exemplary mounting bracket 210 that includes a mounting clip 215. As seen in FIG. 9, the multiple-dose dispensing station component may be a conventional pump bottle “B” that is held securely within the mounting bracket 210. The mounting bracket has a base 220, a back wall 225, a first side wall 230, a second side wall (not shown) and a collar 235 that projects from the back wall and side walls to cantilever over the base such that the collar is adapted to secure the neck of a conventional pump bottle. The mounting bracket also includes a mounting clip 215 attached to the back wall 225 (although it may be attached to other elements). The clip 215 may be any conventional clip for hanging onto a rail or any conventional clip with moveable elements that can be separated and returned to a closed position to securely hold the mounting bracket onto an object or edge.

### EXAMPLE 5

This example was provided to illustrate a single-dose hand sanitizer packet dispensing station component holding a plurality of single-dose hand sanitizer packets. FIG. 10. is an illustration showing a perspective view of an exemplary single-dose hand sanitizer packet dispensing station component 300. The single-dose hand sanitizer packet dispensing station component 300 may have any suitable configuration to hold a plurality of single-dose hand sanitizer dispensing packets. In this example, the dispensing station component has a several parallel sides forming a cube; however other configurations are contemplated and the dispensing station may have one or more curved or irregular sides or may even be spherical. More particularly, single-dose hand sanitizer packet dispensing station component 300 may have a front face 310 that includes a flap 315. The component 300 may have a back side (not shown), a top side 320 and a bottom side (not shown), and a first vertical side 325 and a second vertical side 330. While the flap 315 may be configured to pivot open thereby providing access to a plurality of single-dose hand sanitizer packets 335, a variety of other configurations are contemplated including, but not limited to, removable strips, resealable plastic closures, slots, self-feeding dispensing ports, cam or hinge activated openings that push or dispense an individual packet, or the like.

The present invention has been described in general and in detail by way of examples. The words used are words of description rather than of limitation. Persons of ordinary skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein and the appended claims should not be limited to the description of the preferred versions herein.

We claim:

1. A hand sanitizing kit comprising:
at least one single-dose hand sanitizer packet dispensing station component,
the single-dose hand sanitizer packet dispensing station containing a plurality of single-dose hand sanitizer packets and being adapted to dispense the single-dose hand sanitizer packets; and
at least one multiple-dose hand sanitizer dispensing station component.

2. The kit of claim 1 wherein the single-dose hand sanitizer packet dispensing station component includes a mount for releasably secure placement of the single-dose hand sanitizer packet dispensing station component.

3. The kit of claim 1 wherein the single-dose hand sanitizer packet dispensing station component includes a mount for secure placement of the single-dose hand sanitizer packet dispensing station component.

4. The kit of claim 1 wherein the multiple-dose hand sanitizer dispensing station component is a hand sanitizer pump dispenser, a spray dispenser, foam dispenser, pressurized aerosol or pressured foam dispenser, or dip station.

5. The kit of claim 1 wherein the multiple-dose hand sanitizer dispensing station component includes a mount for releasably secure placement of the multiple-dose hand sanitizer dispensing station component.

6. The kit of claim 1 wherein the multiple-dose hand sanitizer dispensing station component includes a mount for secure placement of the multiple-dose hand sanitizer dispensing station component.

7. The kit of claim 5 wherein the mount is adapted to secure the multiple-dose hand sanitizer dispensing station component to an IV pole, a bed footboard, bed rail, a wall, wall-mounted rail system, a panel, a shelf, a cart, cart-rails, cart handles, traction pole, computer equipment, or a table.

8. The kit of claim 1 further comprising instructions or information about positions in a medical setting to locate the single-dose hand sanitizer packet dispensing station component or multiple-dose hand sanitizer dispensing station component to provide accessible hand sanitizing, or instructions or information about how to use the single-dose hand sanitizer packets or the single-dose hand sanitizer packet dispensing station component or multiple-dose hand sanitizer dispensing station component, or information providing motivation for or describing benefits of using hand sanitizer, or instructions or information about how to locate the single-dose hand sanitizer packet dispensing station component or multiple-dose hand sanitizer dispensing station components to define a patient care zone.

9. The kit of claim 1 further comprising indicia on or associated with the dispensing station components to enhance visibility or recognition of the dispensing station components, or to provide information or instructions for using the dispensing station components, or to provide motivation, or inspiration to use the dispensing station components, or to create an association between the dispensing station components, or to create an association between the dispensing station components and hand sanitizing.

10. The kit of claim 1 wherein the single-dose hand sanitizer packet dispensing station component or the multiple-dose hand sanitizer dispensing station component define a planar surface that includes a retaining zone; and the kit further comprises an inclusion disposed within the retaining zone, wherein the inclusion is a promotional item, an instruction item or an information item.

11. The kit of claim 1 wherein the single-dose hand sanitizer packet dispensing station includes a plurality of single-dose hand sanitizer packets and a plurality of single-dose hand moisturizer packets and/or the at least one of the multiple-dose hand sanitizer components includes hand moisturizer.

12. A system for accessible hand sanitizing in a medical setting comprising:
at least one single-dose hand sanitizer packet dispensing station components,
the single-dose hand sanitizer packet dispensing station containing a plurality of single-dose hand sanitizer packets and being adapted to dispense the single-dose hand sanitizer packets;
a plurality of multiple-dose hand sanitizer dispensing station components;
mounts for one or more of the single-dose hand sanitizer packet dispensing station components or multiple-dose hand sanitizer dispensing station components; and
instructions or information about positions in the medical setting to locate the single-dose hand sanitizer packet dispensing station components or multiple-dose hand sanitizer dispensing station components to provide accessible hand sanitizing.

13. The system of claim 12 further comprising instructions or information about how to use the single-dose hand sanitizer packets or the single-dose hand sanitizer packet dispensing station component or multiple-dose hand sanitizer dispensing station component, or information providing motivation for or describing benefits of using hand sanitizer, or instructions or information about how to locate the single-dose hand sanitizer packet dispensing station component or multiple-dose hand sanitizer dispensing station components to define a patient care zone.

14. The system of claim 12 further comprising indicia on or associated with the dispensing station components to enhance visibility or recognition of the dispensing station components, or to provide information or instructions for using the dispensing station components, or to provide motivation, or inspiration to use the dispensing station components, or to create an association between the dispensing station components, or to create an association between the dispensing station components and hand sanitizing.

15. The system of claim 12 wherein the single-dose hand sanitizer packet dispensing station components or the multiple-dose hand sanitizer dispensing station components define a planar surface that includes a retaining zone; and the system further comprises an inclusion disposed within the retaining zone, wherein the inclusion is a promotional item, an instruction item or an information item.

16. A method of enabling hand sanitizing in a medical setting comprising:
providing at least one single-dose hand sanitizer packet dispensing station component,
the single-dose hand sanitizer packet dispensing station component containing a plurality of single-dose hand sanitizer packets and being adapted to dispense the single-dose hand sanitizer packets;
providing a plurality of multiple-dose hand sanitizer dispensing station components;
providing mounts for at least a portion of the single-dose hand sanitizer packet dispensing station components or multiple-dose hand sanitizer dispensing station components; and
providing instructions or information about positions in the medical setting to locate the single-dose hand sanitizer packet dispensing station components or multiple-dose hand sanitizer dispensing station components to provide accessible hand sanitizing.

17. The method of claim 16 further comprising providing instructions or information about how to use the single-dose hand sanitizer packets or the single-dose hand sanitizer packet dispensing station component or multiple-dose hand sanitizer dispensing station component, or information providing motivation for or describing benefits of using hand sanitizer, or instructions or information about how to locate the single-dose hand sanitizer packet dispensing station component or multiple-dose hand sanitizer dispensing station components to define a patient care zone.

18. The method of claim 16 further comprising providing indicia on or associated with the dispensing station components to enhance visibility or recognition of the dispensing station components, or to provide information or instructions for using the dispensing station components, or to provide motivation, or inspiration to use the dispensing station components, or to create an association between the dispensing station components, or to create an association between the dispensing station components and hand sanitizing.

19. The method of claim 16 further comprising providing an inclusion disposed within a retaining zone defied on a planar surface of the single-dose hand sanitizer packet dispensing station components or the multiple-dose hand sanitizer dispensing station components, wherein the inclusion is a promotional item, an instruction item or an information item.
